(19) United States
(12) Patent Application Publication
(10) Pub. No.: US 2010/0006099 A1
(43) Pub. Date: Jan. 14, 2010

(54) HYDROGEN SUPPLY SYSTEM, AND BUILDING STRUCTURE AND CAPSULE STRUCTURE HAVING THE SYSTEM

(76) Inventor: Wataru Murota, Ishikawa (JP)

Correspondence Address: OSHA LIANG L.L.P., TWO HOUSTON CENTER, 909 FANNIN, SUITE 3500, HOUSTON, TX, 77010, US

(21) Appl. No.: 12/374,922

(22) PCT Filed: Jul. 24, 2007
(86) PCT No.: PCT/JP2007/064487

§ 371 Date: Jul. 10, 2009

(30) Foreign Application Priority Data
Jul. 25, 2006 (JP) 2006-224715

(51) Int. Cl. A61H 33/14; A61G 10/00

(52) U.S. Cl. 128/205.26

(57) ABSTRACT

A hydrogen supply system provides hydrogen into a room from a hydrogen supply means through a hydrogen supply pipe. The system includes a hydrogen agitating means to ensure an even distribution of the supplied hydrogen in the room. The system further includes an on-off plug and an exhaust port in conjunction with a sensor and a controller to prevent the hydrogen concentration in the room from increasing to or reaching higher than a necessary level. Furthermore, the hydrogen supply system may be installed and used in building structures and capsule structures.

### TECHNICAL FIELD

The present invention relates systems, building structures and capsule structures having a means for supplying hydrogen and a means for controlling hydrogen supply.

### BACKGROUND ART

In recent years, adverse effects of reactive oxygen species on the human body are being revealed along with the progress in medicine. There are various reactive oxygen species and methods have been contemplated for reducing such adverse effects of the reactive oxygen species on the human body by reacting part of them with hydrogen introduced in the body.

### DISCLOSURE OF THE INVENTION

### Problems to be Solved by the Invention

Conventionally, in order to introduce hydrogen into the human body, a method has been adopted wherein a liquid in which hydrogen concentration has been artificially increased is orally ingested. This method, however, has a disadvantage that hydrogen may not be ingested in large quantity because the concentration of hydrogen dissolved in the liquid is limited.

Filling a room with a certain kind of gas has already been proposed, for example, in the case of oxygen (References 1 to 3). Use of hydrogen for such operation has, however, been unknown so far and, since hydrogen has a very wide range of explosion limit of 4.0% to 74.2% in comparison with other gases, a certain amount of care must be paid for indoor structures and ventilation systems.

Patent Reference 1: Japanese Unexamined Utility Model Publication No. 1988-78036

Patent Reference 2: Japanese Unexamined Patent Publication No. 1993-103764

Patent Reference 3: Japanese Unexamined Patent Publication No. 1996-154982

### Means for Solving the Problems

The present invention has been made in the light of such problems and is intended to introduce more hydrogen into the body in comparison with methods based on orally ingesting hydrogen-containing liquids, by increasing hydrogen concentration in the air in a room under a safe atmosphere not exceeding the lower explosion limit of hydrogen.

In order to solve the problems, a hydrogen supply system of Claim 1 of the present application comprises a hydrogen supply means for supplying hydrogen into a room and an air agitating means for agitating the supplied hydrogen with the air inside the room.

A hydrogen supply system of Claim 2 of the present application includes in the system a sensor for detecting the concentration of the hydrogen supplied into the room.

A hydrogen supply system of Claim 3 of the present application includes in the system a controller in conjunction with the sensor.

A hydrogen supply system of Claim 4 of the present application includes in the system an on-off plug in conjunction with the controller for blocking a pathway communicating the hydrogen supply means and the inside of the room.

A hydrogen supply system of Claim 5 of the present application includes in the system an exhaust means in conjunction with the controller for exhausting the air in the room outside the room.

A building structure of Claim 6 of the present application comprises the hydrogen supply system of any one of Claims 1 to 5.

A building structure of Claim 7 of the present application is the building structure according to Claim 6, wherein one or more air agitating means are disposed at corners of the building structure.

A building structure of Claim 8 of the present application is the building structure according to Claim 6 or 7, wherein the top or the whole of the building is formed in a dome shape.

A building structure of Claim 9 of the present application is the building structure according to any one of Claims 6 to 8, wherein the hydrogen supply means and the air agitating means are disposed in such a manner that the hydrogen supplied from the hydrogen supply means may flow upward from the bottom to the top of the building structure.

A building structure of Claim 10 of the present application is the building structure according to any one of Claims 6 to 9, which includes an airtight space shut off in some manner from the outside air.

A capsule structure of Claim 11 of the present application comprises the hydrogen supply system of any one of Claims 1 to 5.

A capsule structure of Claim 12 of the present application is the capsule structure according to Claim 1, which includes an airtight space shut off in some manner from the outside air.

### Effect of the Invention

According to the hydrogen supply system claimed in Claim 1 of the present application, since the hydrogen is supplied into the room while mixing the supplied hydrogen with the air in the room using the agitating means, the hydrogen with a low specific gravity is mixed with the air in the room to maintain a constant distribution of hydrogen concentration in the room, but not to fill up any part of the room with the hydrogen, so that the risk of explosion may be avoided.

According to the hydrogen supply system claimed in Claim 2 of the present application, the hydrogen concentration in the room may be determined and values as premises for controlling the amount of hydrogen to be supplied into the room or exhausted may be determined.

According to the hydrogen supply system claimed in Claim 3 of the present application, operation of the controller may be enabled in conjunction with the hydrogen concentration in the room on the basis of the values determined by the sensor.

According to the hydrogen supply system claimed in Claim 4 of the present application, the plug for blocking a pathway communicating the hydrogen supply means and the room can operate on the basis of the operation of the controller in conjunction with the hydrogen concentration in the room to control the amount of hydrogen to be supplied into the room. Thereby, an amount of hydrogen needed in the room can be supplied while eliminating the risk of hydrogen explosion to realize a necessary and safe hydrogen supply system.

According to the hydrogen supply system claimed in Claim 5 of the present application, since the air in the room is exhausted outside the room, when the hydrogen concentration becomes unnecessarily high, the adverse effects on anyone in the room and the risk of explosion may be avoided.

According to the building structure claimed in Claim 6 of the present application, the inside of the room may be maintained at a necessary and safe hydrogen concentration so that anyone in the room may ingest a large amount of hydrogen in a necessary and safe manner.

According to the building structure claimed in Claim 7 of the present application, since the air agitating means are disposed at corners of the building structure, the flammable hydrogen may be prevented from stagnating at the corners of the building structure where agitation may not be made by an agitating means provided only at the center and from exceeding the lower explosion limit of concentration.

According to the building structure claimed in Claim 8 of the present application, since the top or the whole of the building is formed in a dome shape, the hydrogen may be prevented from stagnating in part of the building structure and exceeding the lower explosion limit of concentration.

According to the building structure claimed in Claim 9 of the present application, since the hydrogen supply means and the air agitating means are disposed in such a manner that the hydrogen supplied from the hydrogen supply means may flow upward from the bottom to the top of the building structure, the air in the room may always circulate and the hydrogen may be prevented from stagnating in part of the building structure and exceeding the lower explosion limit of concentration.

According to the building structure claimed in Claim 10 of the present application, since it includes a means for shutting off the inside of the room from the outside and sealing the room in an airtight manner, the hydrogen concentration in the room may be prevented from decreasing so that more effective systems in which smaller amounts of hydrogen supplied may suffice may be built.

According to the capsule structure claimed in Claim 11 of the present application, systems may be built in which anyone may ingest a large amount of hydrogen simply and inexpensively, without constructing large-scale and expensive systems such as building structures.

According to the capsule structure claimed in Claim 12 of the present application, since it includes a means for shutting off the inside of the room from the outside and sealing the room in an airtight manner, in addition to being simple and inexpensive, the amount of hydrogen to be supplied may be reduced to allow more inexpensive systems to be built.

### BEST MODE FOR CARRYING OUT THE INVENTION

Embodiments of the present invention will be described with reference to the drawings. The present invention relates to systems and building structures for maintaining hydrogen at necessary and safe concentrations in rooms. As used in the present invention, a “room” refers to a space partitioned by walls or the like from the outside regardless of its configuration and the “outside” refers to an area surrounding the partitioned space of a room. For example, when a capsule, into which hydrogen is to be supplied, located in a room of a hospital building is intended a room, another room in the hospital building except the capsule is considered as the outside.

FIG. 1 shows a hydrogen supply system 1 according to an embodiment. The hydrogen supply system 1 has a hydrogen supply means 2. The hydrogen supply means 2 may be linked to a means for storing hydrogen such as a hydrogen cylinder or may itself generate hydrogen in a known manner. Hydrogen is fed into a room 3 through a supply pipe 4 communicating the hydrogen supply means 2 and the room 3.

The room 3 has, on a side thereof, an agitator 5 for agitating the hydrogen supplied through the supply pipe 4 and the air in the room 3 in order to prevent the hydrogen, with a low specific gravity, from being unevenly distributed high up in the room. The agitator 5 may be located high up in the room 3 but is not necessarily limited to such locations.

The room 3 also has a sensor 6 attached to the top or toward the top. The sensor 6 determines hydrogen concentrations in the room 3.

Further, the hydrogen supply system 1 has a controller 7, which is connected with the sensor 6 through a circuit or the like so that it may operate in conjunction with the sensor 6.

The supply pipe 4 is provided with an on-off plug 8 at the inside, which may operate in conjunction with the sensor 6 through the controller 7. When a hydrogen concentration determined by the sensor 6 exceeds a certain threshold, the on-off plug will be operated by the controller 7 having detected the hydrogen concentration so that the amount of hydrogen supplied from the hydrogen supply means 2 through the supply pipe 4 into the room 3 may be controlled.

When the amount of hydrogen in the room 3 determined by the sensor 6 exceeds a certain threshold, the controller having detected the hydrogen concentration will operate an exhaust port 9 to exhaust the hydrogen-containing air in the room 3 to the outside 10. The location of the exhaust port 9 is not limited or it may not necessarily be provided. Further, the hydrogen supply means 2 may also act as an exhausting means so that the exhaust port 9 may be omitted.

It may be predicted that simple provision of an air agitator only high up in a room of a building structure may allow hydrogen to stagnate at high concentrations at the corners of the room, allowing it to exceed the lower explosion limit of concentration. As such, it is contemplated that air agitators are located at top corners of the room, as shown in FIG. 2. In this case, agitators 11 may preferably be provided at the four corners or may preferably be provided toward such corners as well.

When air agitators are provided at top corners in a room of a building, however, it may not be possible in some cases to eliminate the risk that hydrogen may in part stagnate to exceed the lower explosion limit of concentration. As such, the top of a building may be formed into a hemispherical dome 12, as shown in FIG. 3 so that hydrogen, while flowing upward, may converge at a point at the apex in the room and, in addition, an agitator 13 may be provided at the apex to avoid stagnation of the hydrogen in an easy and safe manner. In this case, the top of the building must only be formed in such a manner that hydrogen may not stagnate at any particular area, instead of being necessarily formed into a complete dome. For example, only the four corners or the peripheral areas may be arcuate and the top of the building may be flat and horizontal.

Further, as shown in FIG. 4, when the ceiling 14 is composed of an air permeable material such as meshes and part of the wall is provided with a passage 16 partitioned by an inner wall 15 from the room, in which an air agitating means such as a fan is provided, the hydrogen-containing air in the room may always circulate in the room, along the ceiling 14 and through the passage 16 to prevent the hydrogen from stagnating in any part of the room. Although the provision of the air agitating means 17 was described in this embodiment, other methods of and/or other means for circulating the hydrogen-containing air in the room, along the ceiling 14 and through the passage 16 may also be provided as appropriate.

According to the building structures described above, since the airtightness of the room is low, it is conceivable that hydrogen may circulate with the air or the like from the outside to decrease the hydrogen concentration in the room, necessitating to supply a large amount of hydrogen. In order to prevent this from occurring, it is contemplated that some measures may be taken for shutting off the inside of the room from the outside in the building structure. For example, it is contemplated to use materials for filling in the gaps around the windows and doors for enhancing hermetic sealing and to apply airtight films of particular types to the walls of the room so that the hydrogen may not diffuse outside the room. Examples of airtight films may include metallic films, such as known aluminum films, and resin films.

In addition, each of the building structures described above tends to be expensive for its being as a building. As such, rendering it a capsule structure as shown in FIGS. 5 and 6 allows to build an inexpensive and simple system, providing for a more effective, widespread utilization of hydrogen systems in societies.

According to the capsule structure described above, similarly to the building structure, since the airtightness of the room is low, it is conceivable that it may not represent an effective hydrogen supply system. In order to prevent this from occurring, it is contemplated also for the capsule structure that some measures may be taken for shutting off the inside of the room from the outside. As an example, it is contemplated as mentioned above to use materials for filling in the gaps between the upper lid and the lower bowl where a person may lie of the capsule for enhancing hermetic sealing and to apply airtight films of particular types to the walls of the room so that the hydrogen may not diffuse outside the room.

### BRIEF DESCRIPTION OF THE DRAWINGS

FIG. 1 is a schematic side sectional view illustrating an example of a building structure according to the present invention;

FIG. 2 is a schematic side sectional view illustrating an example of a building structure according to the present invention wherein one or more air agitating means are disposed at corners of the building structure;

FIG. 3 is a schematic side sectional view illustrating an example of a building structure according to the present invention wherein the top of the building is formed into a dome shape;

FIG. 4 is a schematic side sectional view illustrating an example of a building structure according to the present invention wherein hydrogen supply means and air agitating means are disposed in such a manner that hydrogen supplied from the hydrogen supply means may flow upward from the bottom to the top of the building structure;

FIG. 5 is a schematic front sectional view illustrating an example of a capsule structure according to the present invention; and

FIG. 6 is a schematic side sectional view illustrating an example of a capsule structure according to the present invention.

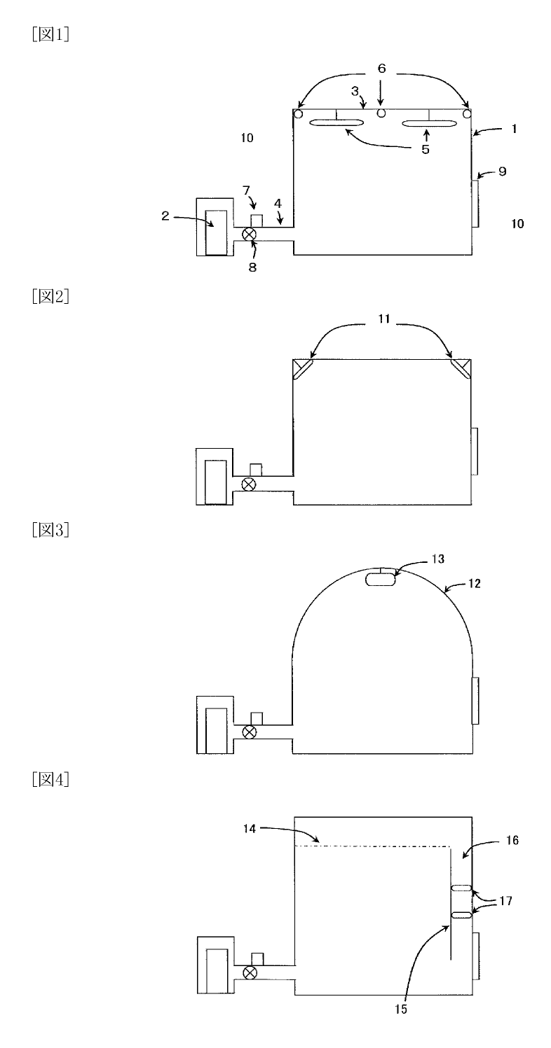

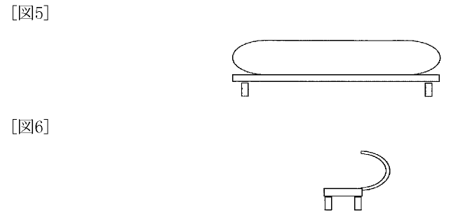

### DESIGNATION OF REFERENCE NUMERALS

1 hydrogen supply system

2 hydrogen supply means

3 inside of room

4 supply pipe

5 agitator

6 sensor

7 controller

8 on-off plug

9 exhaust port

10 outside

11 agitator

12 dome

13 agitator

14 ceiling

15 inner wall

16 passage

17 air agitator

1. A hydrogen supply system comprising a hydrogen supply means for supplying hydrogen into a room and an air agitating means for agitating the supplied hydrogen with the air at the inside of the room.

2. The hydrogen supply system according to claim 1, further comprising a sensor for detecting the concentration of the hydrogen supplied into the room.

3. The hydrogen supply system according to claim 2, further comprising a controller in conjunction with the sensor.

4. The hydrogen supply system according to claim 3, further comprising an on-off plug in conjunction with the controller for blocking a pathway communicating the hydrogen supply means with the inside of the room.

5. The hydrogen supply system according to claim 1, further comprising an exhaust means for exhausting the air in the room.

6. A building structure comprising the hydrogen supply system of claim 1.

7. The building structure according to claim 6, wherein one or more air agitating means are disposed at corners of the building structure.

8. The building structure according to claim 6, wherein the top of the building or the whole building is formed in a dome shape.

9. The building structure according to claim 6, wherein the hydrogen supply means and the air agitating means are disposed in a manner that the hydrogen supplied from the hydrogen supply means flows upward from the bottom of the building structure to the top of the building structure.

10. The building structure according to claim 6, further comprising an airtight space shut off from the outside air.

11. A capsule structure comprising the hydrogen supply system of claim 1.

12. The capsule structure according to claim 11, further comprising an airtight space shut off from the outside air.

13. A building structure comprising the hydrogen supply system of claim 2.

14. A building structure comprising the hydrogen supply system of claim 3.

15. A building structure comprising the hydrogen supply system of claim 4.

16. A building structure comprising the hydrogen supply system of claim 5.

17. A capsule structure comprising the hydrogen supply system of claim 2.

18. A capsule structure comprising the hydrogen supply system of claim 3.

19. A capsule structure comprising the hydrogen supply system of claim 4.

20. A capsule structure comprising the hydrogen supply system of claim 5.
